(19) United States
(12) Patent Application Publication
(10) Pub. No.: US 2025/0240430 A1
(43) Pub. Date: Jul. 24, 2025

(54) V-DMC BASE MESH MOTION FIELD CODING

(71) Applicant: QUALCOMM Incorporated, San Diego, CA (US)

(72) Inventors: Geert Van der Auwera, San Diego, CA (US); Anique Akhtar, San Diego, CA (US); Reetu Hooda, San Diego, CA (US); Adarsh Krishnan Ramasubramonian, Irvine, CA (US); Marta Karczewicz, San Diego, CA (US)

(21) Appl. No.: 19/029,480

(22) Filed: Jan. 17, 2025

Related U.S. Application Data
(60) Provisional application No. 63/624,699, filed on Jan. 24, 2024.

(51) Int. Cl. H04N 19/137; H04N 19/105; H04N 19/17; H04N 19/70

(52) U.S. Cl. CPC H04N 19/137; H04N 19/105; H04N 19/17; H04N 19/70

(57) ABSTRACT

A method of encoding or decoding mesh data includes: for a current vertex of mesh vertices of the mesh data, determining a motion vector predictor based on respective weighted averages of respective motion vectors in a candidate list for the current vertex; and encoding or decoding the current vertex based on the motion vector predictor.

This application claims the benefit of U.S. Provisional Patent Application 63/624,699, filed Jan. 24, 2024, the entire content of which is incorporated by reference.

### TECHNICAL FIELD

This disclosure relates to video-based coding of dynamic meshes.

### BACKGROUND

In the realm of computer graphics and virtual reality, meshes are the building blocks that may be used to represent three dimensional (3D) objects. Meshes are the digital equivalent of a wireframe model, defining the shape and surface of an object. A mesh is a collection of vertices, edges, and faces that define the shape of a 3D object. Vertices are the points that define the corners of the object. Edges are the lines connecting the vertices. Faces are the polygons (usually triangles or quadrilaterals) formed by the edges, which define the surface of the object. Meshes are versatile and have a wide range of applications, including, but not limited to: 3D modeling and animation, virtual and augmented reality, 3D printing, medical imaging, and architectural design. As 3D models become increasingly complex, file sizes of such models may grow significantly. Mesh compression techniques may be used to reduce the size of mesh files.

### SUMMARY

This disclosure describes example motion vector prediction techniques that may be employed to efficiently encode and decode meshes. In 3D video and virtual reality, accurate motion vector prediction may be important for efficient compression and transmission of 3D mesh sequences. As described in more detail, motion vector prediction is a technique used to determine a motion vector for a current vertex. The motion vector for the current vertex may be an estimate of the movement of the current vertex in a 3D mesh from one frame to the next.

By predicting the motion vector for a current vertex, an encoder may reduce the amount of data needed to transmit to determine the motion vector for the current vertex. The disclosed techniques may utilize weighted averaging to improve the accuracy of motion vector prediction. An encoder or decoder may consider a set of motion vectors from neighboring vertices. The encoder or decoder may calculate the distance between the current vertex and the vertex positions corresponding to each candidate motion vector. The candidate motion vectors may be weighted based on their respective distances. Closer vertices may have a higher weight, contributing more to the final predicted motion vector. This better ensures that the prediction is heavily influenced by the most relevant neighbors. The encoder or decoder may use the weighted average of the candidate motion vectors as the predicted motion vector for the current vertex. By calculating the distance between the current vertex and potential candidate vertices, the encoder or decoder may prioritize vertices that are spatially closer. By utilizing motion vectors from a previously encoded or decoded reference mesh, the encoder or decoder may incorporate historical information into the prediction process.

By considering the relative distances between vertices, the weighted averaging techniques may provide more accurate motion vector predictions, especially in complex motion scenarios. More accurate motion vector prediction may lead to better compression efficiency, resulting in smaller file sizes and lower bandwidth requirements. Accurate motion vector prediction may help maintain the visual quality of 3D video and virtual reality content, even at lower bitrates.

The disclosed techniques may help to capture long-term motion patterns and may be particularly effective for complex, dynamic scenes. More accurate predictions may lead to fewer bits representing the residual error between the predicted and actual motion vectors. This may lead to a smaller bitrate and reduced transmission costs. Precise motion vector prediction may enable more efficient compression techniques, such as motion compensation. Enhanced coding efficiency may result in higher compression ratios and improved quality of the reconstructed 3D mesh.

In an example, a method of encoding or decoding mesh data includes: for a current vertex of mesh vertices of the mesh data, determining a motion vector predictor based on respective weighted averages of respective motion vectors in a candidate list for the current vertex; and encoding or decoding the current vertex based on the motion vector predictor.

In an example, a device for generating mesh data includes: a memory configured to store the mesh data; and one or more processors coupled to the memory, implemented in circuitry, and configured to: for a current vertex of mesh vertices of the mesh data, determine a motion vector predictor based on respective weighted averages of respective motion vectors in a candidate list for the current vertex; and encode or decode the current vertex based on the motion vector predictor.

In an example, non-transitory computer-readable storage media having instructions encoded thereon, the instructions configured to cause processing circuitry to: for a current vertex of mesh vertices of the mesh data, determine a motion vector predictor based on respective weighted averages of respective motion vectors in a candidate list for the current vertex; and encode or decode the current vertex based on the motion vector predictor.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example of a V-DMC decoding process, in accordance with the techniques of this disclosure.

FIG. 3 shows an example of resampling to enable efficient compression of a 2D curve, in accordance with the techniques of this disclosure.

FIG. 4 shows a displaced curve that has a subdivision structure, while approximating the shape of the original mesh, in accordance with the techniques of this disclosure.

FIG. 5 shows a block diagram of a pre-processing system, in accordance with the techniques of this disclosure.

FIGS. 6A and 6B show an example of an initial sub-optimal parameterization and a computed parameterization with a limited number of patches, in accordance with the techniques of this disclosure.

FIGS. 7A-7C show examples of an original mesh, a decimated mesh, and a deformed mesh, in accordance with the techniques of this disclosure.

FIG. 8. shows an example of an original (wireframe) mesh versus a deformed (flat shaded) mesh, in accordance with the techniques of this disclosure.

FIG. 9 shows an example of an intra frame encoding process, in accordance with the techniques of this disclosure.

FIG. 10 shows a block diagram of an intra decoding process, in accordance with the techniques of this disclosure.

FIG. 11 shows a block diagram of an arithmetic decoding process of displacements bitstream, in accordance with the techniques of this disclosure.

FIG. 12 shows an example of a mid-point subdivision scheme, in accordance with the techniques of this disclosure.

FIG. 13 shows motion field candidate construction, in accordance with the techniques of this disclosure.

FIG. 14 is a flowchart illustrating an example method for encoding and decoding meshes, in accordance with the techniques of this disclosure.

### DETAILED DESCRIPTION

This disclosure describes techniques that may enhance the efficiency of video compression, such as for Dynamic Mesh Coding (V-DMC). Base mesh motion field coding is a component of V-DMC and may include representing the movement of the vertices of the mesh over time. One way to indicate the movement of vertices is using a motion vector. The motion vector of a vertex may indicate the position change of that vertex from frame to frame.

In some techniques, an encoder may signal coordinate information of the motion vector to a decoder. However, reduce the amount of information that needs to be signaled, the encoder and decoder may use motion vector prediction to predict the motion vector. For instance, the encoder and decoder may utilize motion vectors of previously encoded or decoded vertices to generate motion vector predictors that predict the actual motion vector for a current vertex. This way, rather than signaling the coordinate information of the actual motion vector, the encoder may signal information for selecting a motion vector predictor and possibly a difference between the motion vector predictor and the actual motion vector. Signaling information for selecting a motion vector predictor and possibly a difference between the motion vector predictor and the actual motion vector may require less signaling as compared to signaling the coordinates of the motion vector. Accordingly, by utilizing motion vector prediction, significant compression gains may be achieved.

Motion vector predictors may be used to predict the motion of a particular mesh vertex based on the motion of its neighboring vertices. In one or more examples described in this disclosure, the examples of neighboring vertices may be vertices in a current mesh that includes the current vertex for which the motion vector is being determined. In some examples, a neighboring vertex may be a vertex in another mesh, referred to as a reference mesh.

As an example, the encoder and decoder may utilize the same techniques to generate a candidate list of motion vectors for a current vertex. In some examples, the candidate list of motion vectors may include motion vectors of vertices in a current mesh that includes the current vertex, and/or motion vectors of vertex or vertices in a reference mesh that was previously encoded or decoded. Because the encoder and decoder use the same techniques to generate the candidate list of motion vectors for the current vertex, the candidate list may be same at the encoder side and decoder side.

The encoder and decoder may utilize same techniques to determine a motion vector predictor based on the motion vectors in the candidate list, such as by weighted averaging, as an example. Accordingly, the motion vector predictor determined on the encoder side and decoder side may be the same motion vector predictor. The encoder and decoder may determine a motion vector for the current vertex using the motion vector predictor.

With the example techniques, the motion vector predictor may be a better predictor of the actual motion vector as compared to other techniques. That is, the motion vector predictor may be closer in value to the actual motion vector than other techniques that use motion vector prediction. As noted above, by accurately predicting the motion vector (e.g., determine a motion vector predictor that better predicts the actual motion vector), an encoder may reduce the amount of information needed to be signaled to represent the actual motion vector. The process of constructing candidate motion vector list may include creating a list of potential motion vectors for a given vertex. A good candidate list may significantly improve the efficiency of the motion estimation and coding process. Enhancing motion vector prediction may include exploring more sophisticated prediction models or incorporating additional contextual information. Optimizing candidate motion vector list construction may include developing strategies to prioritize the most likely motion vectors, reducing the search space and improving coding efficiency.

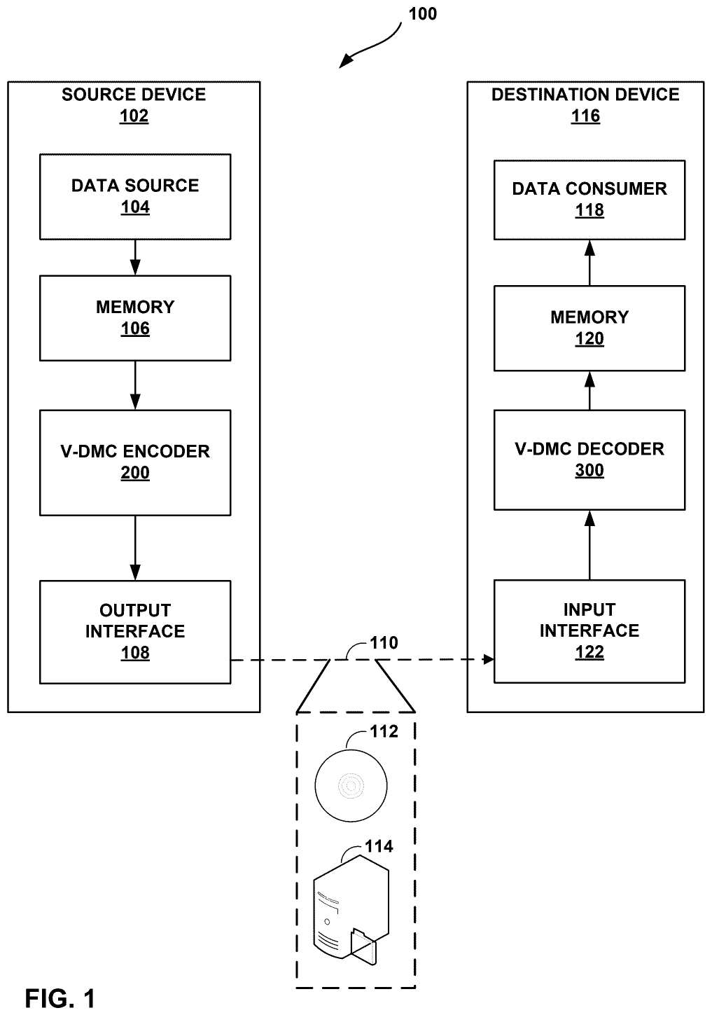

FIG. 1 is a block diagram illustrating an example encoding and decoding system 100 that may perform the techniques of this disclosure. The techniques of this disclosure are generally directed to coding (encoding and/or decoding) meshes. The coding may be effective in compressing and/or decompressing data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to mesh motion field coding. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to mesh motion field coding. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (i.e., raw, unencoded data) and may provide a sequential series of “frames”) of the data to V-DMC encoder 200, which encodes data for the frames. Data source 104 of source device 102 may include a mesh capture device, such as any of a variety of cameras or sensors, e.g., a 3D scanner or a light detection and ranging (LIDAR) device, one or more video cameras, an archive containing previously captured data, and/or a data feed interface to receive data from a data content provider. Alternatively or additionally, mesh data may be computer-generated from scanner, camera, sensor or other data. For example, data source 104 may generate computer graphics-based data as the source data, or produce a combination of live data, archived data, and computer-generated data. In each case, V-DMC encoder 200 encodes the captured, pre-captured, or computer-generated data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to V-DMC encoder 200 and/or output interface 108, and destination device 116 may include an SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

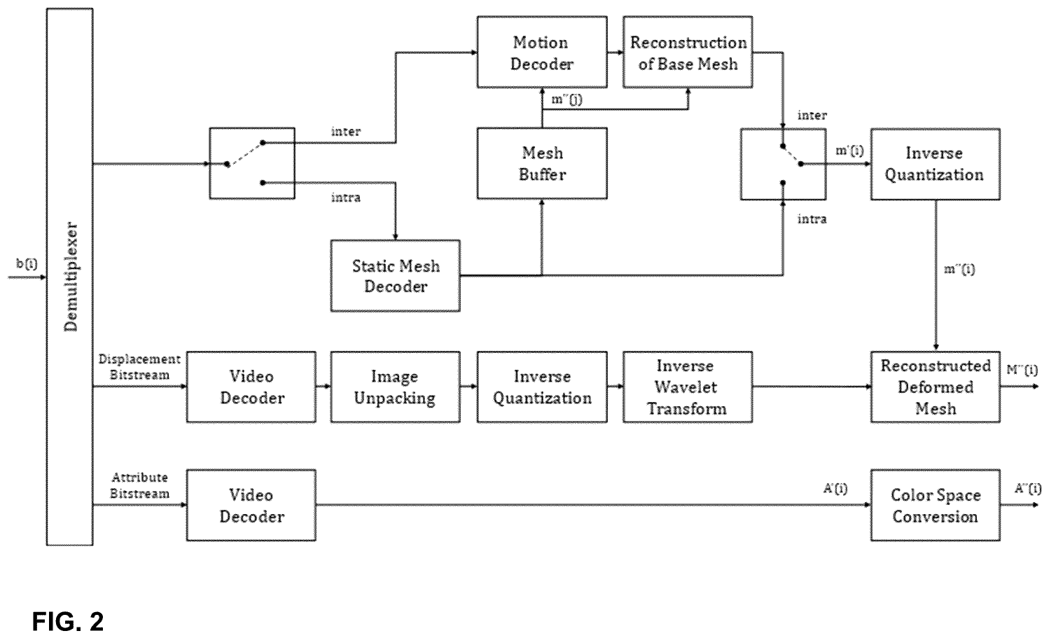

The MPEG working group 7 (WG7), also known as the 3D graphics and haptics coding group (3DGH), is currently standardizing the video-based coding of dynamic mesh representations (V-DMC) targeting XR use cases. The current test model is based on the call for proposals result, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, and encompasses the pre-processing of the input meshes into approximated meshes with typically fewer vertices named the base meshes, which are coded with a static mesh coder (e.g., Google Draco, MPEG's edge breaker implementation, etc.). In addition, V-DMC encoder 200 may estimate the motion of the base mesh vertices and code the motion vectors into the bitstream. The reconstructed base meshes may be subdivided into finer meshes with additional vertices and, hence, additional triangles. The V-DMC encoder 200 may refine the positions of the subdivided mesh vertices to approximate the original mesh. The refinements or vertex displacement vectors may be coded into the bitstream. In the current test model, the displacement vectors are wavelet transformed, quantized, and the coefficients are packed into a 2D frame. The sequence of frames is coded with a typical video coder, for example, HEVC or VVC, into the bitstream. In addition, the sequence of texture frames is coded with a video coder. The architecture of the V-DMC decoder is illustrated in FIG. 2.

FIG. 2 shows an example of a V-DMC decoding process as set forth in WD 2.0 of V-DMC, ISO/IEC JTC1/SC29/WG7, N00546, January 2023. The process of FIG. 2 may be performed by V-DMC decoder 300 and may also be performed, in full or in part, by V-DMC encoder 200.

A detailed description of the proposal that was selected as the starting point for the V-DMC standardization can be found in m59281. The following description will detail the displacement vector coding in the current V-DMC test model and WD 2.0, such as WD 5.0 of V-DMC, ISO/IEC JTC1/SC29/WG7, N00744, October 2023. Additionally, the coding of the base mesh motion field is described.

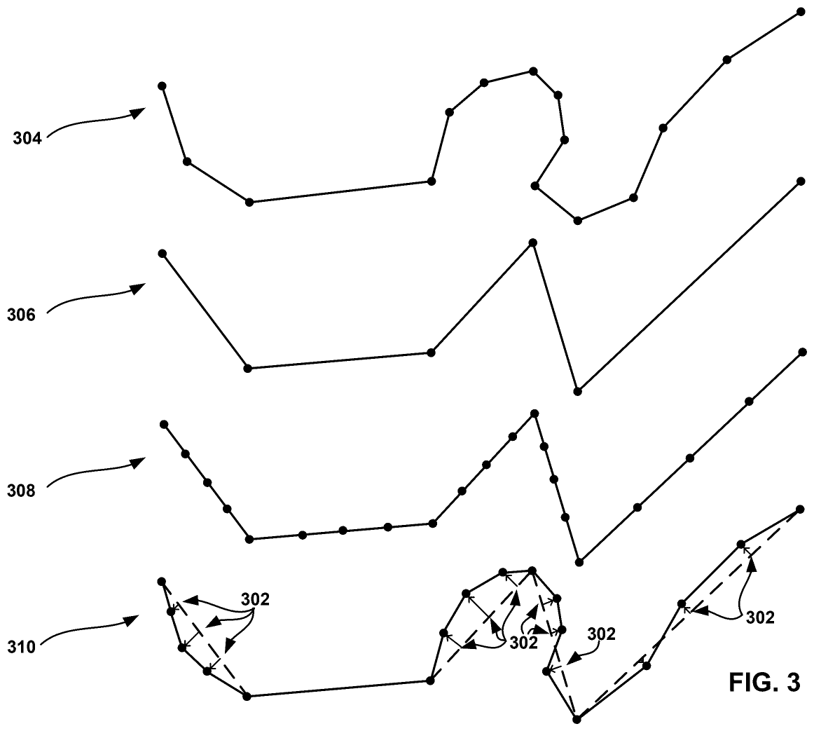

V-DMC encoder 200 and V-DMC decoder 300 may be configured to perform preprocessing. FIG. 3 illustrates examples of proposed pre-processing scheme by using a 2D curve. The same concepts are applied to the input 3D mesh M(i) to produce a base mesh m(i) and a displacement field d(i).

In FIG. 3, the input 2D curve (represented by a 2D polyline), referred to as the “original” curve 304, is first downsampled to generate a base curve/polyline, referred to as the “decimated” curve 306. A subdivision scheme, such as that described in Garland et al, Surface Simplification Using Quadric Error Metrics (https://www.cs.cmu.edu/˜garland/Papers/quadrics.pdf), is then applied to the decimated polyline to generate a “subdivided” curve 308. For instance, in FIG. 3, a subdivision scheme using an iterative interpolation scheme is applied. It consists of inserting at each iteration a new point in the middle of each edge of the polyline. In the example illustrated, two subdivision iterations were applied.

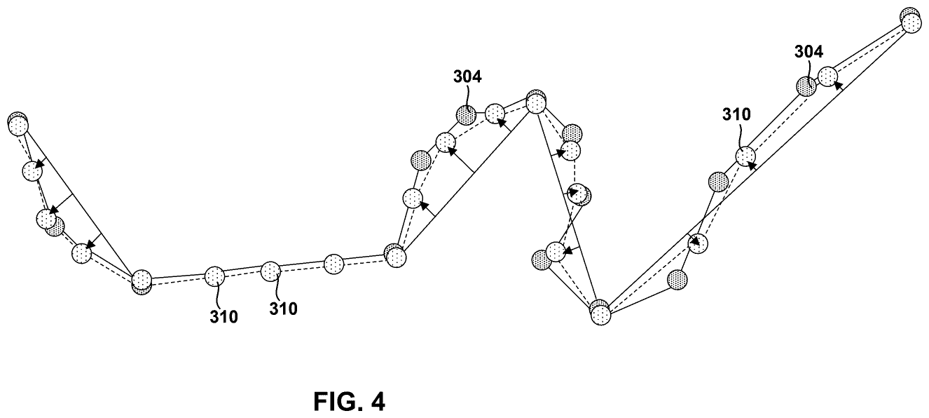

In some examples, the techniques are independent of the chosen subdivision scheme and could be combined with other subdivision schemes. The subdivided polyline is then deformed to get a better approximation of the original curve 304. For example, a displacement vector is computed for each vertex of the subdivided mesh (arrows 302 in FIG. 3) such that the shape of the displaced curve 310 is as close as possible to the shape of the original curve 304 (see FIG. 4). One possible advantage of the subdivided curve 308 is that subdivided curve 308 has a subdivision structure that allows efficient compression, while the subdivided curve 308 offers a faithful approximation of the original curve 304. The compression efficiency is obtained for possibly the following properties:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).

The displaced curve 310 is generated by decoding the displacement vectors associated with the subdivided curve 308 vertices. Besides allowing for spatial/quality scalability, the subdivision structure enables efficient transforms such as wavelet decomposition, which can offer high compression performance.

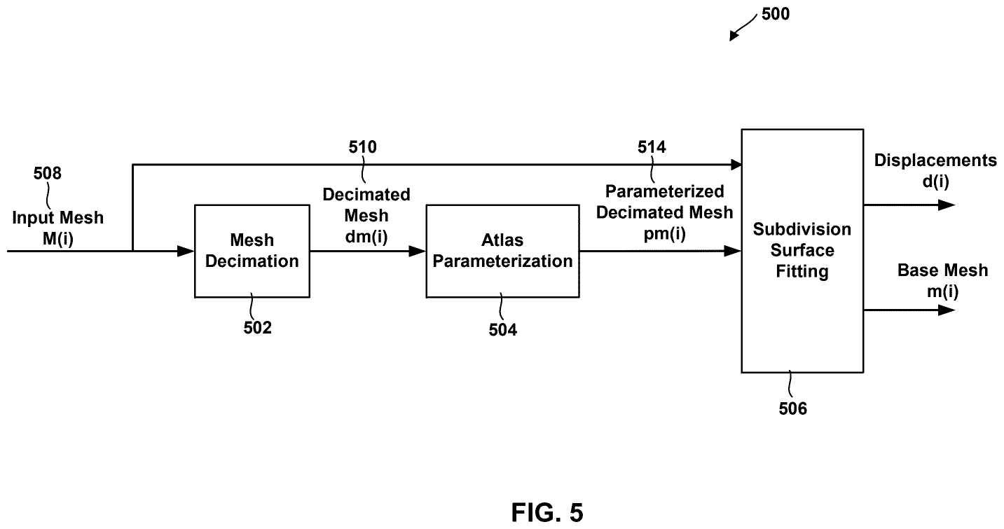

FIG. 5 shows a block diagram of a pre-processing scheme that includes the following sub-blocks (1) Mesh decimation 502, (2) Atlas parameterization 504, and (3) Subdivision surface fitting 506.

The mesh decimation module uses a simplification technique to decimate the input mesh 508 M(i) and produce the decimated mesh 510 dm(i). The decimated mesh 510 dm(i) is then re-parameterized using the UVAtlas tool (e.g., https://docs.microsoft.com/en-us/windows/win32/direct3d9/using-uvatlas). The generated mesh 514 is denoted as pm(i). The UVAtlas tool considers only the geometry information of the decimated mesh 510 dm(i) when computing the atlas parameterization, which is likely sub-optimal for compression purposes. Other parameterization schemes or tools could also be considered with the proposed framework.

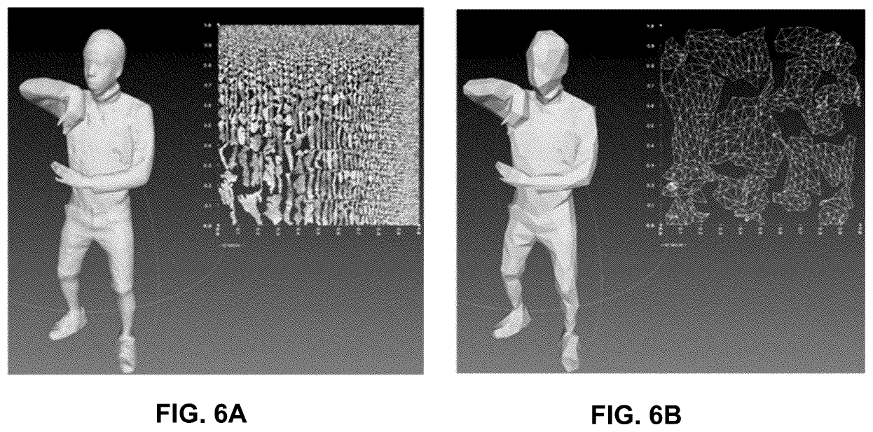

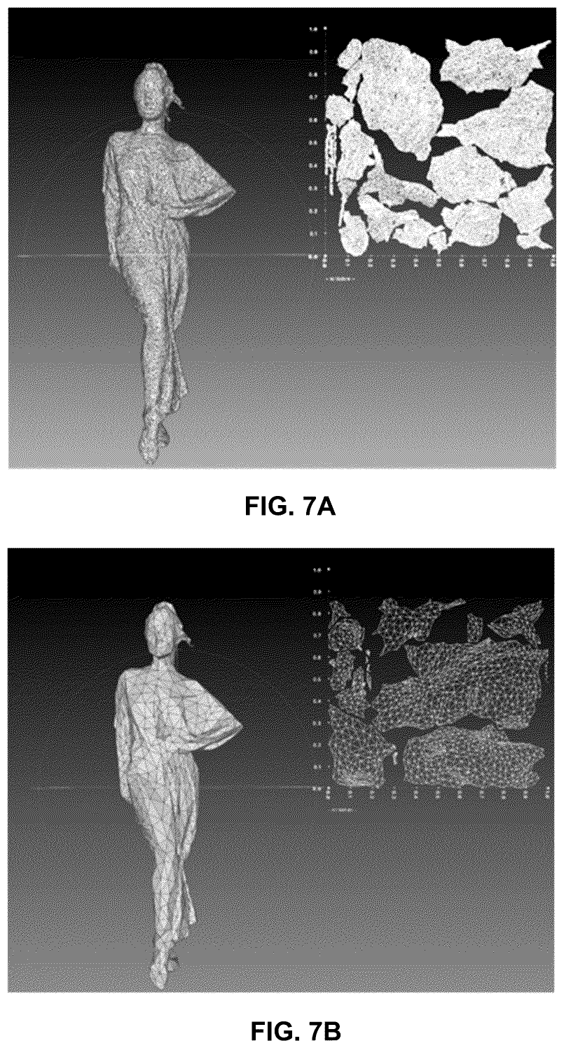

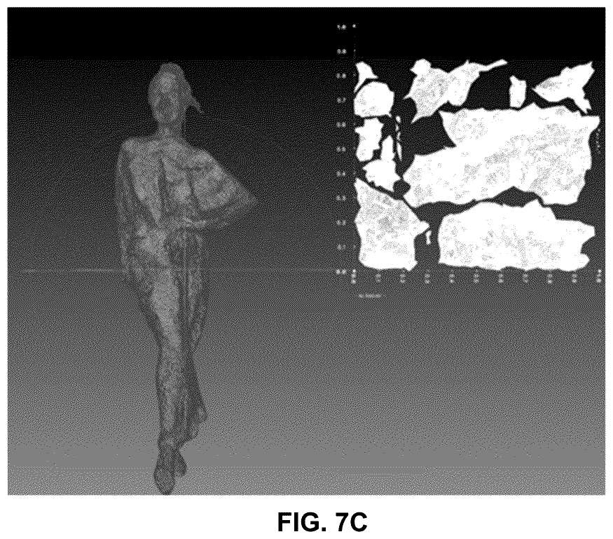

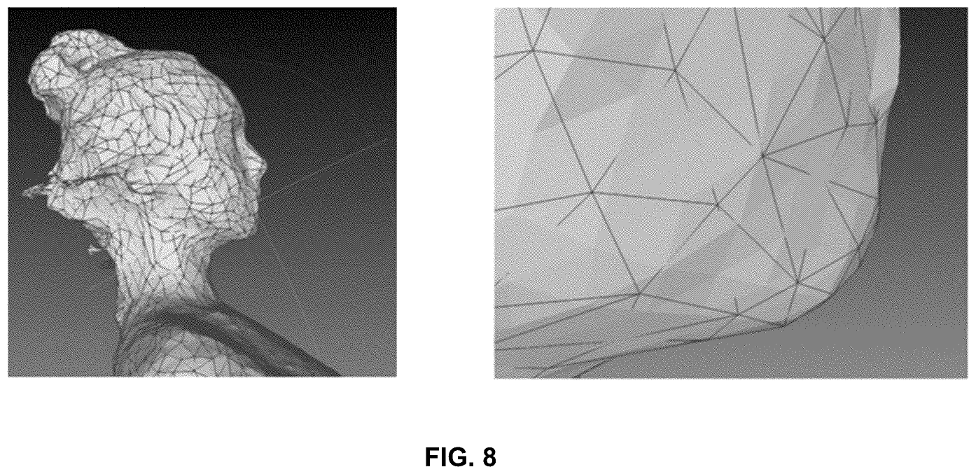

As illustrated in FIGS. 6A and 6B, applying re-parameterization to the input mesh makes it possible to generate a lower number of patches. This reduces parameterization discontinuities and may lead to better RD performance. The subdivision surface fitting module takes as input the re-parameterized mesh pm(i) and the input mesh M(i) and produces the base mesh m(i) together with a set of displacements d(i). First, pm(i) is subdivided by applying the subdivision scheme. The displacement field d(i) is computed by determining for each vertex of the subdivided mesh the nearest point on the surface of the original mesh M(i). FIGS. 7A-7C show an example of re-sampling applied to the first frame of the sequence “longdress”. FIG. 8 compares the original mesh (in wireframe) to the deformed mesh (flat-shaded).

For the Random Access (RA) condition, a temporally consistent re-meshing could be computed by considering the base mesh m(j) of a reference frame with index j as the input for the subdivision surface fitting module. This makes it possible to produce the same subdivision structure for the current mesh M′(i) as the one computed for the reference mesh M′(j). Such a re-meshing process makes it possible to skip the encoding of the base mesh m(i) and re-use the base mesh m(j) associated with the reference frame M(j). This could also enable better temporal prediction for both the attribute and geometry information. In some examples, a motion field f(i) describing how to move the vertices of m(j) to match the positions of m(i) is computed and encoded. Such time-consistent re-meshing may not always possible. Some example techniques compare the distortion obtained with and without the temporal consistency constraint and choose the mode that offers the best RD compromise.

The pre-processing module may not be normative and could be replaced by any other system that produces displaced subdivision surfaces. A possible efficient implementation would constrain the 3D reconstruction module to directly generate displaced subdivision surface and avoids the need for such pre-processing.

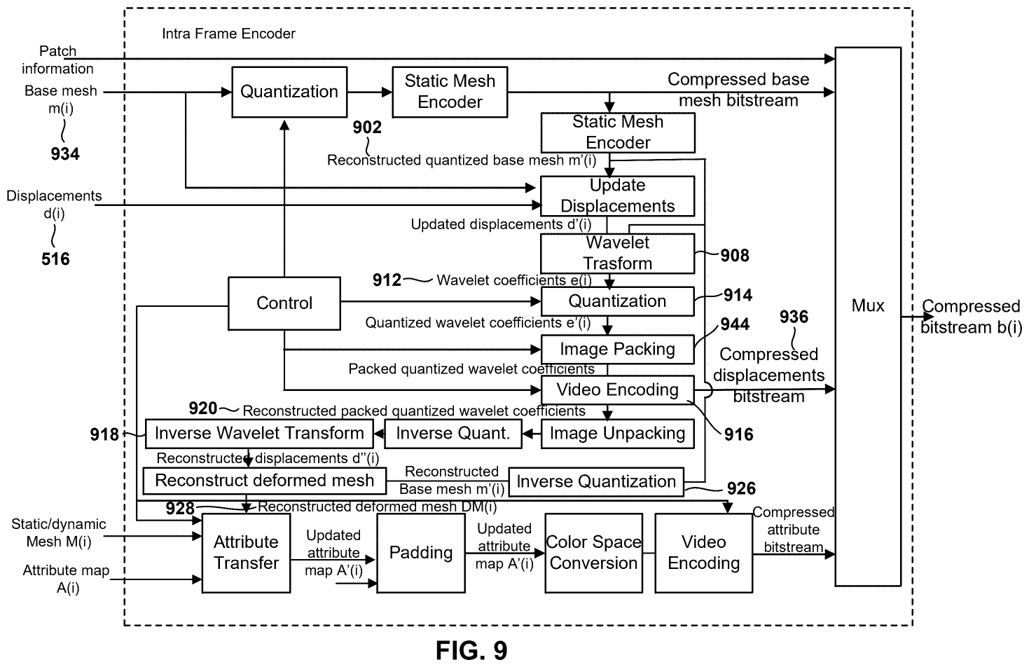

V-DMC encoder 200 and V-DMC decoder 300 may be configured to perform displacements coding. Depending on the application and the targeted bitrate/visual quality, the V-DMC encoder 200 could optionally encode a set of displacement vectors associated with the subdivided mesh vertices, referred to as the displacement field d(i). The intra encoding process, which may be performed by V-DMC encoder 200, is illustrated in FIG. 9.

First, the reconstructed quantized base mesh 902 m′(i) is used to update the displacement field 516 d(i) to generate an updated displacement field d′(i). This process considers the differences between the reconstructed base mesh 902 m′(i) and the original base mesh 934 m(i). By exploiting the subdivision surface mesh structure, a wavelet transform 908 is then applied to d′(i) and a set of wavelet coefficients 912 is generated. The scheme is agnostic of the transform applied and could leverage any other transform, including the identity transform. The wavelet coefficients 912 are then quantized 914, packed 944 into a 2D image/video, and can be compressed 936 by using a traditional image/video encoder 916 (e.g., V-PCC). The reconstructed version of the wavelet coefficients 920 is obtained by applying image unpacking and inverse quantization 926 to the reconstructed wavelet coefficient video 920 generated during the video encoding process. Reconstructed displacements d″(i) are then computed by applying the inverse wavelet transform 918 to the reconstructed wavelet coefficients 920. A reconstructed base mesh m″(i) is obtained by applying inverse quantization 926 to the reconstructed quantized base mesh m′(i). The reconstructed deformed mesh 928 DM(i) is obtained by subdividing m″(i) and applying the reconstructed displacements d″(i) to its vertices.

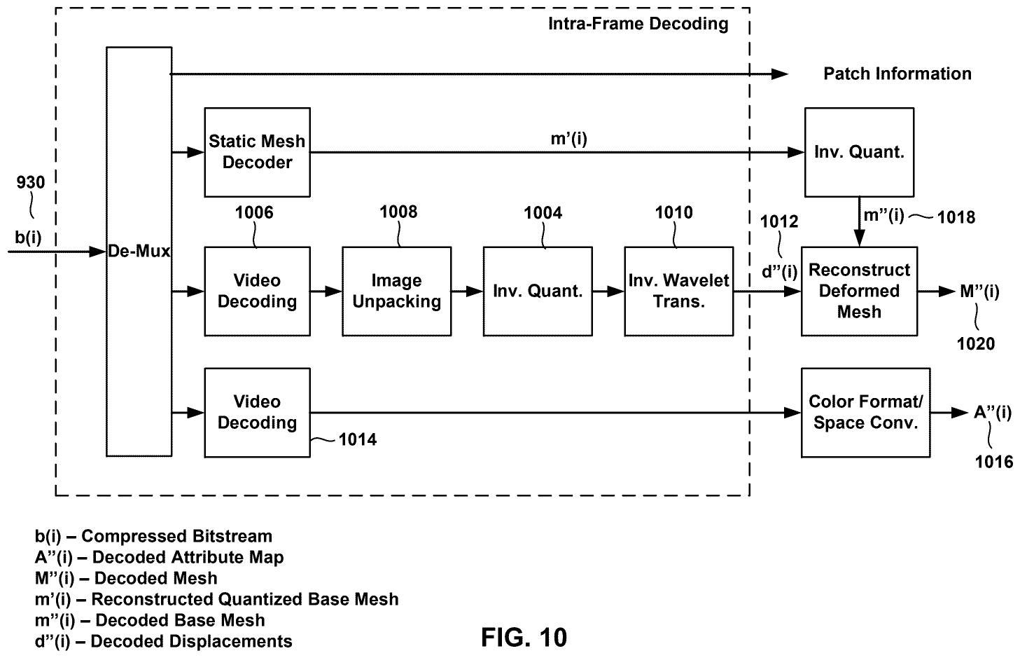

FIG. 10 shows a block diagram of an intra decoding process that may, for example, be performed by V-DMC decoder 300. First, the bitstream is de-multiplexed into separate sub-streams, including:
a mesh sub-stream,
a displacement sub-stream for positions and potentially for each vertex attribute, zero or more attribute map sub-streams, and
an atlas sub-stream containing patch information in the same manner as in V3C/V-PCC.

The mesh sub-stream is fed to the mesh decoder to generate the reconstructed quantized base mesh m′(i). The decoded base mesh m″(i) is then obtained by applying inverse quantization to m′(i). The displacement sub-stream could be decoded by a video/image decoder. The generated image/video is then un-packed and inverse quantization is applied to the transformed (e.g., wavelet) coefficients. The decoded displacement field d″(i) is then generated by applying the inverse transform to the unquantized coefficients. The final decoded mesh is generated by applying the reconstruction process to the decoded base mesh m″(i) and by adding the decoded displacement field d″(i). The attribute sub-stream is directly decoded by the video decoder and the decoded attribute map A″(i) is generated as output.

FIG. 10 shows a block diagram of an intra decoding process that may, for example, be performed by V-DMC decoder 300. First, the bitstream 930 is de-multiplexed into separate sub-streams, including:
a mesh sub-stream,
a displacement sub-stream for positions and potentially for each vertex attribute,
zero or more attribute map sub-streams, and
an atlas sub-stream containing patch information in the same manner as in V3C/V-PCC.

The mesh sub-stream is fed to the mesh decoder to generate the reconstructed quantized base mesh m′(i). The decoded base mesh 1018 m″(i) is then obtained by applying inverse quantization 1004 to m′(i). The displacement sub-stream could be decoded by a video/image decoder 1006. The generated image/video is then un-packed 1008 and inverse quantization 1004 is applied to the transformed (e.g., wavelet) coefficients. The decoded displacement field 1012 d″(i) is then generated by applying the inverse transform 1010 to the unquantized coefficients. The final decoded mesh is generated by applying the reconstruction process to the decoded base mesh m″(i) and by adding the decoded displacement field 1012 d″(i). The attribute sub-stream is directly decoded by the video decoder 1014 and the decoded attribute map A″(i) is generated as output 1016.

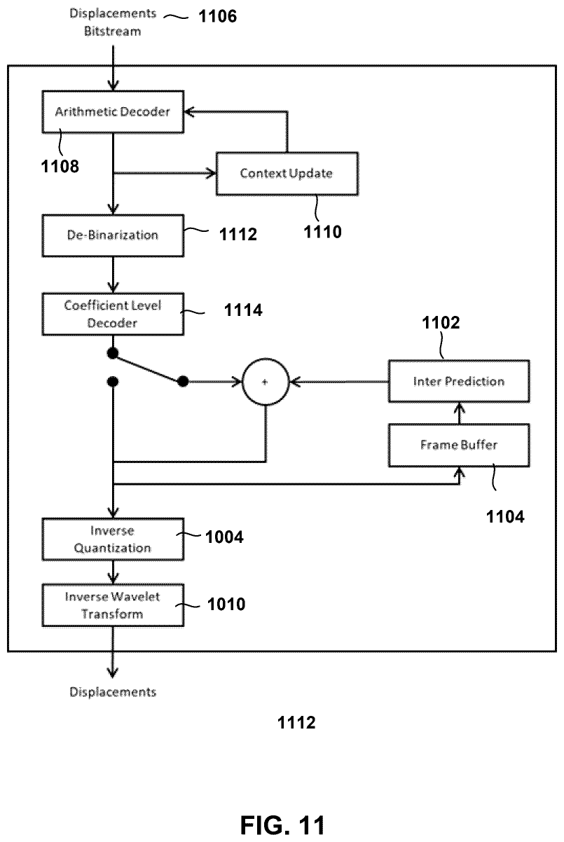

The following describes arithmetic coding of displacements. As an alternative to packing the quantized wavelet coefficients in frames and coding as images or video, a scheme was utilized that directly codes the quantized wavelet coefficients with a block-based arithmetic coder. This scheme is illustrated in FIG. 11. The displacement bitstream is fed into arithmetic decoder 1108. The output of the arithmetic decoder 1108 may be run through context update 1110. De-binarization 1114 may be applied to the output of the arithmetic decoder 1108. The de-binarized output may be fed into coefficient level decoder 1114. The decoded quantized wavelet coefficients are inter predicted 1102 from the reference buffer 1104, which contains quantized wavelet coefficients from prior frames, for example, the preceding frame. The output of the inter prediction 1102 may be summed up with the output of the coefficient level decoder 1114.

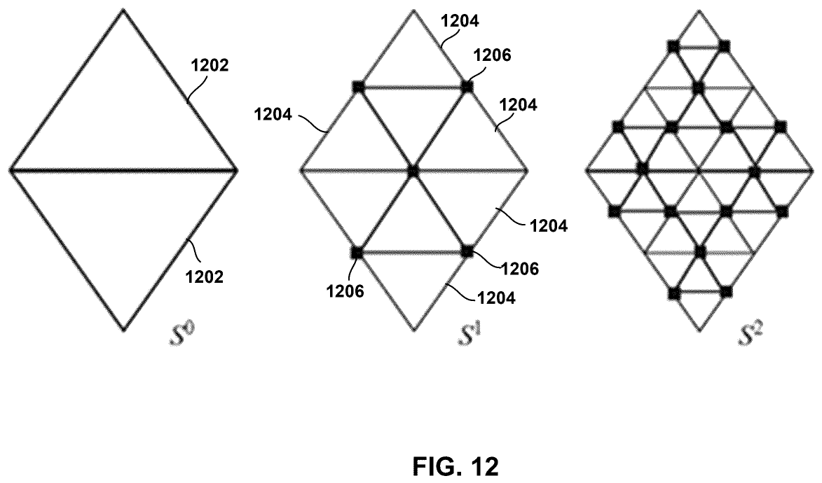

V-DMC encoder 200 and V-DMC decoder 300 may be configured to implement a subdivision scheme. Various subdivision schemes could be considered (e.g., https://www.cs.utexas.edu/users/fussell/courses/cs384g-fall2011/lectures/lecture17-Subdivision_curves.pdf). A possible solution is the mid-point subdivision scheme, which at each subdivision iteration subdivides each triangle into 4 sub-triangles as described in FIG. 12. New vertices 1206 are introduced in the middle of each edge 1202. The subdivision process is applied independently to the geometry and to the texture coordinates since the connectivity for the geometry and for the texture coordinates is usually different. The sub-division scheme computes the position Pos(v₁₂) of a newly introduced vertex v₁₂ at the center of an edge (v₁, v₂), as follows:

$$P o s ( {v}_{12} ) = \frac{1}{2} ( P o s ( {v}_{1} ) + P o s ( {v}_{2} ) ) ,$$

where Pos(v₁) and Pos(v₂) are the positions of the vertices v₁ and v₂.

The same process is used to compute the texture coordinates of the newly created vertex. For normal vectors, an extra normalization step is applied as follows:

$$N ( {v}_{12} ) = \frac{N ( {v}_{1} ) + N ( {v}_{2} )}{‖ N ( {v}_{1} ) + N ( {v}_{2} ) ‖} ,$$

here:
N(v₁₂), N(v₁), and N(v₂) are the normal vectors associated with the vertices v₁₂, v₁, and v₂, respectively.
∥x∥ is the norm2 of the vector x.

V-DMC encoder 200 and V-DMC decoder 300 may be configured to apply wavelet transforms 1010. Various wavelet transforms may be applied (e.g., Kolarov, K and Lynch W. “Wavelet Compression for 3D and Higher-Dimensional Objects”, Proc. of SPIE Conference on Applications of Digital Image Processing, Volume 3164, San Diego, California, pp. 247-260, July 1997). The results reported for CP are based on a linear wavelet transform.

The prediction process is defined as follows:

$$Signal ( v ) ← Signal ( v ) - \frac{1}{2} ( Signal ( {v}_{1} ) + Signal ( {v}_{2} ) )$$

where
v is the vertex introduced in the middle of the edge (v₁, v₂), and
Signal(v), Signal(v₁), and Signal(v₂) are the values of the geometry/vertex attribute signals at the vertices v, v₁, and v₂, respectively.

The updated process is as follows:

$$Signal ( v ) ← Signal ( v ) + \frac{1}{8} {\sum }_{w ∈ {v}^{*}} Signal ( w )$$

where v* is the set of neighboring vertices of the vertex v.

The scheme may allow to skip the update process. The wavelet coefficients could be quantized e.g., by using a uniform quantizer with a dead zone.

Local vs. Canonical Coordinate System for Displacements will now be discussed. The displacement field d(i) is defined in the same cartesian coordinate system as the input mesh. A possible optimization is to transform d(i) from this canonical coordinate system to a local coordinate system, which is defined by the normal to the subdivided mesh at each vertex.

A potential advantage of considering a local coordinate system for the displacements is the possibility to quantize more heavily the tangential components of the displacements compared to the normal component. The normal component of the displacement may have more significant impact on the reconstructed mesh quality than the two tangential components.

V-DMC encoder 200 and V-DMC decoder 300 may be configured to implement packing of wavelet coefficients. The following scheme is used to pack the wavelet coefficients into a 2D image:
Traverse the coefficients from low to high frequency.
For each coefficient, determine the index of the N×M pixel block (e.g., N=M=16) in which it should be stored following a raster order for blocks.
The position within the N×M pixel block is computed by using a Morton order to maximize locality.

Other packing schemes could be used (e.g., zigzag order, raster order). The V-DMC encoder 200 could explicitly signal in the bitstream the used packing scheme (e.g., atlas sequence parameters). This could be done at patch, patch group, tile, or sequence level.

V-DMC encoder 200 may be configured for displacement video encoding. The techniques may be agnostic of which video coding technology is used. When coding the displacement wavelet coefficients, a lossless approach may be used since the quantization is applied in a separate module. Another approach is to rely on the video encoder to compress the coefficients in a lossy manner and apply a quantization either in the original or transform domain.

The following describes base mesh motion field coding. In current VDMC (WD 5.0 of V-DMC, ISO/IEC JTC1/SC29/WG7, N00744, Oct. 2023) and software TMM v6.0, the reference and current base meshes share the same topology. This means that there may be a one-to-one correspondence between triangles of the reference and current base meshes (order of vertices and connectivity). Therefore, motion vectors may be determined by subtracting corresponding 3D vertex positions. The motion vectors would be added to the reference base mesh vertex positions to obtain the current base mesh vertex positions. The coding of this motion field is performed as follows.

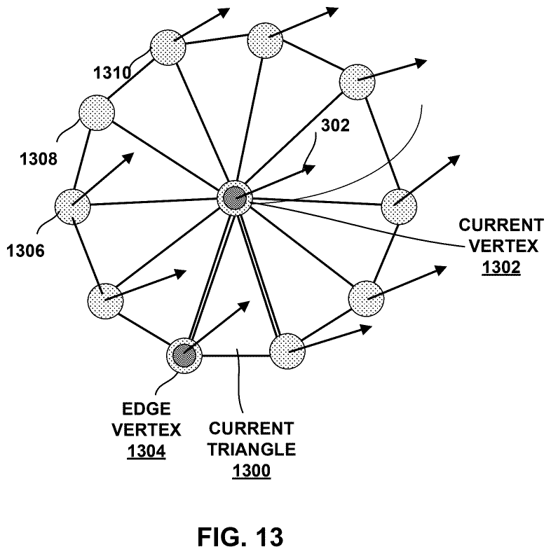

Firstly, the construction of the motion field candidate list is illustrated in FIG. 13. The following are the steps in the MV candidate list construction for all vertices:
a. Access triangle by triangle (e.g., starting with current triangle 1300)
b. Access each triangle edge by edge
c. Access edge vertex by vertex 1304, 1306, 1308, 1310 and determine vertex with highest index in base mesh order (is assigned as current vertex 1302)
d. For current vertex 1302 store second edge vertex 1304 in list if not duplicate
e. Create list with up to three neighboring vertices (can be parameter) and associated MVs
   i. If list full then overwrite last MV in list
   ii. Duplicate vertices are excluded.

Subsequently, the motion vectors may be predicted, a predictor index and residuals may be coded in the bitstream. In the current version, motion vectors 302 are grouped into ‘motion blocks’, typically of size 16 (can be parameter), and one predictor is selected per block. In addition, instead of coding the motion vectors, a skip mode can be signaled. In case of skip mode, the coding of the motion vectors in the motion block is skipped (reference positions are copied, no residual coded). A skip flag is signaled in the bitstream. If skip is disabled, then one predictor is chosen (and residual is coded) from the following three options:
a. Three predictor options:
   i. Zero MV (residual is coded)
   ii. Average of MVs in list without rounding (residual is coded)
   iii. Average of MVs in list with symmetric rounding (residual is coded)

V-DMC encoder 200 and V-DMC decoder 300 may be configured to process a lifting transform parameter set and associated semantics, an example of which is shown in TABLE 1 below.

TABLE 1

| vmc_lifting_transform_parameters( index, ltpIndex ){ | Descriptor |
|---|---|
| vmc_transform_lifting_skip_update_flag[index][ ltpIndex ] | u(1) |
| vmc_transform_lifting_quantization_parameters_x[index][ ltpIndex ] | u(6) |
| vmc_transform_lifting_quantization_parameters_y[index][ ltpIndex ] | u(6) |
| vmc_transform_lifting_quantization_parameters_z[index][ ltpIndex ] | u(6) |
| vmc_transform_log2_lifting_lod_inverse_scale_x[index][ ltpIndex ] | ue(v) |
| vmc_transform_log2_lifting_lod_inverse_scale_y[index][ ltpIndex ] | ue(v) |
| vmc_transform_log2_lifting_lod_inverse_scale_z[index][ ltpIndex ] | ue(v) |
| vmc_transform_log2_lifting_update_weight[index][ ltpIndex ] | ue(v) |
| vmc_transform_log2_lifting_prediction_weight[index][ ltpIndex ] | ue(v) |
| } | |

syntax_element[i][ltpIndex] with i equal to 0 may be applied to the displacement. syntax_element[i][ltpIndex] with i equal to non-zero may be applied to the (i−1)-th attribute, where ltpIndex is the index of the lifting transform parameter set list.

vmc_transform_lifting_skip_update_flag[i][ltpIndex] equal to 1 indicates the step of the lifting transform applied to the displacement is skipped in the vmc_lifting_transform_parameters(index, lptIndex) syntax structure, where ltpIndex is the index of the lifting transform parameter set list.

vmc_transform_lifting_skip_update_flag[i][ltpIndex] with i equal to 0 may be applied to the displacement. vmc_transform_lifting_skip_update_flag[i][ltpIndex] with i equal to non-zero may be applied to the (i−1)-th attribute.

vmc_transform_lifting_quantization_parameters_x[i][ltpIndex] indicates the quantization parameter to be used for the inverse quantization of the x-component of the displacements wavelets coefficients. The value of vmc_transform_lifting_quantization_parameters_x[index] [ltpIndex] shall be in the range of 0 to 51, inclusive.

vmc_transform_lifting_quantization_parameters_y[i][ltpIndex] indicates the quantization parameter to be used for the inverse quantization of the y-component of the displacements wavelets coefficients. The value of vmc_transform_lifting_quantization_parameters_x[index] [ltpIndex] shall be in the range of 0 to 51, inclusive.

vmc_transform_lifting_quantization_parameters_z[i][ltpIndex] indicates the quantization parameter to be used for the inverse quantization of the z-component of the displacements wavelets coefficients. The value of vmc_transform_lifting_quantization_parameters_x[index] [ltpIndex] shall be in the range of 0 to 51, inclusive.

vmc_transform_log2_lifting_lod_inverse_scale_x[i][ltpIndex] indicates the scaling factor applied to the x-component of the displacements wavelets coefficients for each level of detail.

vmc_transform_log2_lifting_lod_inverse_scale_y[i][ltpIndex] indicates the scaling factor applied to the y-component of the displacements wavelets coefficients for each level of detail.

vmc_transform_log2_lifting_lod_inverse_scale_z[i][ltpIndex] indicates the scaling factor applied to the z-component of the displacements wavelets coefficients for each level of detail.

vmc_transform_log2_lifting_update_weight[i][ltpIndex] indicates the weighting coefficients used for the update filter of the wavelet transform. vmc_transform_log2_lifting_prediction_weight[i][ltpIndex] the weighting coefficients used for the prediction filter of the wavelet transform.

V-DMC decoder 300 may be configured to perform inverse image packing of wavelet coefficients. Inputs to this process are:
width, which is a variable indicating the width of the displacements video frame,
height, which is a variable indicating the height of the displacements video frame,
bitDepth, which is a variable indicating the bit depth of the displacements video frame,
dispQuantCoeffFrame, which is a 3D array of size width×height×3 indicating the packed quantized displacement wavelet coefficients.
blockSize, which is a variable indicating the size of the displacements coefficients blocks,
positionCount, which is a variable indicating the number of positions in the subdivided submesh.

The output of this process is dispQuantCoeffArray, which is a 2D array of size positionCount×3 indicating the quantized displacement wavelet coefficients.

Let the function extracOddBits(x) be defined as follows:

```
x = extracOddBits( x ) {
  x = x & 0x55555555
  x = (x | (x >> 1)) & 0x33333333
  x = (x | (x >> 2)) & 0x0F0F0F0F
  x = (x | (x >> 4)) & 0x00FF00FF
  x = (x | (x >> 8)) & 0x0000FFFF
}
    Let the function computeMorton2D(i) be defined as follows:
(x, y) = computeMorton2D( i ) {
  x = extracOddBits( i >> 1 )
  y = extracOddBits( i )
}
    The wavelet coefficients inverse packing process proceeds as follows:
pixelsPerBlock = blockSize * blockSize
widthInBlocks = width / blockSize
shift = (1 << bitDepth) >> 1
for( v = 0; v < positionCount; v++ ) {
  blockIndex = v / pixelsPerBlock
  indexWithinBlock = v % pixelsPerBlock
  x0 = (blockIndex % widthInBlocks) * blockSize
  y0 = (blockIndex / widthInBlocks) * blockSize
  (x, y) = computeMorton2D(index WithinBlock)
  x = x0 + x
  y = y0 + y
  for( d = 0; d < 3; d++ ) {
    dispQuantCoeffArray[ v ][ d ] = dispQuantCoeffFrame[ x ][ y ][ d ] − shift
  }
}
```

V-DMC decoder 300 may be configured to perform inverse quantization of wavelet coefficients. Inputs to this process are:
positionCount, which is a variable indicating the number of positions in the subdivided submesh.
dispQuantCoeffArray, which is a 2D array of size positionCount×3 indicating the quantized displacement wavelet coefficients.
subdivisionIterationCount, which is a variable indicating the number of subdivision iterations.
liftingQP, which is a 1D array of size 3 indicating the quantization parameter associated with the three displacement dimensions.
liftingLevelOfDetaillnverseScale, which is a 1D array of size 3 indicating the inverse scale factor associated with the three displacement dimensions.
levelOfDetailAttributeCounts, a 1D array of size (subdivisionIterationCount+1) indicating the number of attributes associated with each subdivision iteration.
bitDepthPosition, which is a variable indicating the bit depth of the mesh positions.

The output of this process is dispCoeffArray, which is a 2D array of size positionCount×3 indicating the dequantized displacement wavelet coefficients.

The wavelet coefficients inverse quantization process proceeds as follows:

```
for ( d =0; d < 3; ++d) {
  qp = liftingQP[ d ]
  iscale[ d ] = qp >= 0 ? pow( 0.5, 16 − bitDepthPosition + ( 4 − qp ) / 6) : 0.0
  ilodScale[ d ] = liftingLevelOfDetailInverseScale[ d ]
}
vcount0 = 0
for( i = 0; i < subdivisionIterationCount; i++ ) {
  vcount1 = levelOfDetailAttributeCounts[ i ]
  for( v = vcount0; v < vcount1; v++ ) {
    for( d = 0; d < 3; d++ ) {
      dispCoeffArray[ v ][ d ] = dispQuantCoeffArray[ v ][ d ] * iscale[ k ]
    }
  }
  vcount0 = vcount1
  for( d = 0; d < 3; d++ ) {
    iscale[d] *= ilodScale[ d ]
  }
}
```

V-DMC decoder 300 may be configured to apply an inverse linear wavelet transform. Inputs to this process are:
positionCount, which is a variable indicating the number of positions in the subdivided submesh.
dispCoeffArray, which is a 2D array of size positionCount×3 indicating the displacement wavelet coefficients.
levelOfDetailAttributeCounts, a 1D array of size (subdivisionIterationCount+1) indicating the number of attributes associated with each subdivision iteration.
edges, which is a 2D array of size positionCount×2 which indicates for each vertex v produced by the subdivision process described above, the two indices (a, b) of the two vertices used to generated it (i.e., v generated as the middle of the edge (a, b)).
updateWeight, which is a variable indicating the lifting update weight.
predWeight, which is a variable indicating the lifting prediction weight.
skipUpdate, which is a variable indicating whether the update operation should be skipped (when 1) or not (when 0).

The output of this process is dispArray, which is a 2D array of size positionCount×3 indicating the displacements to be applied to the mesh positions.

The inverse wavelet transform process proceeds as follows:

```
for( i = 0; i < subdivisionIterationCount; i++ ) {
  vcount0 = levelOfDetailAttributeCounts[i]
  vcount1 = levelOfDetailAttributeCounts[i + 1]
  for ( v = vcount0; skipUpdate == 0 && v < vcount1; ++v ) {
    a = edges[v][0]
    b = edges[v][1]
    for( d = 0; d < 3; d++ ) {
      disp = updateWeight * dispCoeffArray[v][d]
      signal[a][d] −= disp
      signal[b][d] −= disp
    }
  }
  for ( v = vcount0; skipUpdate == 0 && v < vcount1; ++v ) {
    a = edges [v][0]
    b = edges[v][1]
    for( d = 0; d < 3; d++ ) {
      dispCoeffArray[v][d] +=
                        predWeight * (dispCoeffArray[a][d] +
dispCoeffArray[b][d])
    }
  }
}
for ( v = 0; v < positionCount; ++v ) {
  for( d = 0; d < 3; d++ ) {
    disp Array[v][d] = dispCoeffArray[v][d]
  }
}
```

V-DMC decoder 300 may be configured to perform positions displacement. The inputs of this process are:
positionCount, which is a variable indicating the number of positions in the subdivided submesh.
positionsSubdiv, which is a 2D array of size positionCount×3 indicating the positions of the subdivided submesh.
dispArray, which is a 2D array of size positionCount×3 indicating the displacements to be applied to the mesh positions.
normals, which is a 2D array of size positionCount×3 indicating the normals to be used when applying the displacements to the submesh positions.
tangents, which is a 2D array of size positionCount×3 indicating the tangents to be used when applying the displacements to the submesh positions.
bitangents, which is a 2D array of size positionCount×3 indicating the tangents to be used when applying the displacements to the submesh positions.

The output of this process is positionsDisplaced, which is a 2D array of size positionCount×3 indicating the positions of the displaced subdivided submesh.

The positions displacement process proceeds as follows:

```
for ( v = 0; v < positionCount; ++v ) {
  for( d = 0; d < 3; d++ ) {
    positionsDisplaced[ v ][ d ] = positionsSubdiv[ v ][ d ] +
      dispArray[ v ][ 0 ] * normals[ v ][ d ] +
      dispArray[ v ][ 1 ] * tangents[ v ][ d ] +
      dispArray[ v ][ 2 ] * bitangents[ v ][ d ]
  }
}
```

The base mesh working draft description is included in Annex H of WD 5.0 of V-DMC, ISO/IEC JTC1/SC29/WG7, N00744, Oct. 2023. The following reproduces some sections that are relevant to motion field coding in the base mesh.

### “H.8.1.3.1.1 General Basemesh Sequence Parameter Set RBSP Syntax

| bmesh_sequence_parameter_set_rbsp( ) { | Descriptor |
|---|---|
| bmsps_sequence_parameter_set_id | u(4) |
| bmesh_profile_tier_level( ) | |
| bmsps_intra_mesh_codec_id | u(8) |
| bmsps_inter_mesh_codec_id | u(8) |
| bmsps_geometry_3d_bit_depth_minus1 | u(5) |
| bmsps_inter_mesh_max_num_mvp_cand_minus1 | u(2) |
| bmsps_mesh_attribute_count | u(7) |
| for( i = 0; i < bmsps_mesh_attribute_count; i++ ) { | |
| bmsps_mesh_attribute_index[ i ] | u(8) |
| bmsps_mesh_attribute_type_id[ i ] | u(4) |
| bmsps_attribute_bit_depth_minus1[ i ] | u(5) |
| bmsps_attribute_msb_align_flag[ i ] | u(1) |
| } | |
| bmsps_intra_mesh_post_reindex_method | ue(v) |
| bmsps_log2_max_mesh_frame_order_cnt_lsb_minus4 | ue(v) |
| bmsps_max_dec_mesh_frame_buffering_minus1 | ue(v) |
| bmsps_long_term_ref_mesh_frames_flag | u(1) |
| bmsps_num_ref_mesh_frame_lists_in_bmsps | ue(v) |
| for( i = 0; i < bmsps_num_ref_mesh_frame_lists_in_bmsps; i++ ) | |
| bmesh_ref_list_struct( i ) | |
| bmsps_inter_mesh_motion_group_size_minus1 | ue(v) |
| bmsps_inter_mesh_max_num_neighbours_minus1 | ue(v) |
| bmsps_extension_present_flag | u(1) |
| if( bmsps_extension_present_flag ) { | |
| bmsps_extension_count | u(8) |
| } | |
| if( bmsps_extension_count ){ | |
| bmsps_extensions_length_minus1 | ue(v) |
| for( i = 0; i < bmsps_extension_count; i++ ) { | |
| bmsps_extension_type[ i ] | u(8) |
| bmsps_extension_length[ i ] | u(16) |
| bmsps_extension( bmsps_extension_type[ i ], bmsps_extension_length[ i ] ) | |
| } | |
| } | |
| rbsp_trailing_bits( ) | |
| } | |

. . . ”

### “H.8.1.3.9 Basemesh Inter Submesh Data Unit Syntax

| sismu_inter_unit_default ( subMeshID, vertexCount ) { | Descriptor |
|---|---|
| if( vertexCount > 0 ) | |
| sismu_derived_mv_present_flag[ subMeshID ] | ae(v) |
| for( i = 0; i < vertexCount ; i++ ) { | |
| if(sismu_derived_mv_present_flag[ subMeshID ]) | |
| sismu_mv_signalled_flag[ subMeshID ][ i ] | ae(v) |
| } | |
| groupSize = bmsps_inter_mesh_motion_group_size_minus1 + 1 | |
| groupCount = ( vertexCount − 1) / groupSize + 1 | |
| vStart = 0 | |
| for( g = 0; g < groupCount: g++ ) { | |
| sismu_skip_group_flag[ subMeshID ][ g ] | ae(v) |
| if( !sismu_skip_group_flag[ subMeshID ][ g ] ) { | |
| sismu_mv_pred_mode_group[ subMeshID ][ g ] | ae(v) |
| if ( g == (groupCount − 1) ) | |
| groupSize = submeshMotionCount− groupSize * (groupCount | |
| − 1) | |
| for( v = vStart; v < (vStart+groupSize); v++ ) { | |
| if( sismu_mv_signalled_flag[ subMeshID ][ v ]) { | |
| for( k = 0; k < 3; k++ ) { | |
| sismu_mv_residual_abs_gt0[ subMeshID ][ v ][ k ] | ae(v) |
| if (sismu_mv_residual_abs_gt0[ subMeshID ][ v ][ k ]) { | |
| sismu_mv_residual_sign[ subMeshID ][ v ][ k ] | ae(v) |
| sismu_mv_residual_abs_gt1[ subMeshID ][ v ][ k ] | ae(v) |
| if (sismu_mv_residual_abs_gt1[ subMeshID ][ v ][ k ]) | |
| sismu_mv_residual_abs_rem[ subMeshID ][ v ][ k ] | ae(v) |
| } | |
| } | |
| } | |
| }//v | |
| } | |
| vStart += groupSize | |
| } | |
| } | |

. . . ”

### H.8.3.8 Blasemesh Inter Submesh Data Unit Semantics

sismu_derived_mv_present_flag[subMeshTD] indicates sismu_my_signalled_flag is present in the bitstream. If sismu_derived_mv_present_flag[subMeshTD] is 0, sismu_mv_signalled_flag[subMeshTD][v] is always inferred as 1.

It is a requirement of bitstream conformance that if sismu_derived_mv_present_flag[subMeshTD] is equal to 1 for a submesh with submesh TD equal to subMeshID, mesh_position_deduplicate_method, if present in the corresponding intra submesh data unit, shall be equal to MESH_POSITION_DEDUP_NONE.

sismu_my_signalled_flag[subMeshTD][v] indicates a motion vector for the vertex with index v is present in the bitstream. When sismu_mv_signalled_flag[subMeshTD][v] is not present in the bitstream, sismu_my_signalled_flag[subMeshTD][v] isinferred as 1.

sismu_skip_group_flag[subMeshID][g] indicates a motion vector associated with vertices in the group with index g of the current submesh, with submesh ID equal to subMeshID, is inferred as 0.

sismu_mv_residual_abs_gt[subMeshID][v][k] indicates whether the k-th component of the motion vector prediction residual associated with the vertex with index v of the current submesh, with submesh ID equal to subMeshID has an absolute value higher than zero (when 1), or not (when 0).

sismu_mv_residual_sign[subMeshID][v][k] indicates whether the k-th component of the motion vector prediction residual associated with the vertex with index v of the current submesh, with submesh ID equal to subMeshID has a positive sign (when 1), or not (when 0). If sismu_mv_residual_sign[v][k] is not present it shall be inferred to be equal to 1.

sismu_mv_residual_abs_gt1[subMeshID][v][k] indicates whether the k-th component of the motion vector prediction residual associated with the vertex with index v of the current submesh, with submesh ID equal to subMeshID has an absolute value higher than one (when 1), or not (when 0). If sismu_mv_residual_abs_gt1[v][k] is not present it shall be inferred to be equal to 0.

sismu_mv_residual_abs_rem[subMeshID][v][k] indicates the absolute value of the k-th component of the motion vector prediction residual associated with the vertex with index v of the current submesh, with submesh ID equal to subMeshID minus 2. If sismu_mv_residual_abs_rem[v][k] is not present it shall be inferred to be equal to 0.

The k-th component of the motion vector prediction residual VertexMotionVectorResiduals[v][k] associated with the vertex with index v of the current submesh, with submesh ID equal to subMeshID is computed as follows:

$$VertexMotionVectorResiduals [ v ] [ k ] = sismu\_mv \_residual \_sign [ v ] [ k ] ? 1 : - 1 ) * ( sismu\_mv \_residual \_abs \_gt0 [ v ] [ k ] + sismu\_mv \_residual \_abs \_gt1 [ v ] [ k ] + sismu\_mv \_residual \_abs \_rem [ v ] [ k ] )$$

### H.12.3 Reconstruction of Vertices for INTER Submeshes

Inputs to this process are:
motionGroupSize which is the size of vertices grouping in motion vector coding.
submeshFaceCount, which is a variable indicating the number of faces in the current and in the reference submeshes.
submeshFaceIndices, which is a 2D array of size submeshFaceCount by 3 indicating the connectivity indices associated with the current and with the reference submeshes.
referenceSubmeshVertexPositions, which is a 2D array of size submeshVertexCount by 3 indicating the positions of the reference submesh positions.
referenceSubmeshVertexPositionsClean, which is a 2D array of size referenceSubmeshVertexCountClean by 3 indicating the positions of the reference integrated submesh positions.
submeshVertexNeighboursCounts, which is a 1D array indicating the number of neighbours for each vertex of the submesh.
submeshVertexNeighbours, which is a 2D array of size submeshVertexCount by (bmsps_inter_mesh_max_num_neighbours_minus1+1) indicating for each vertex v the indices of its neighbours according to the mesh connectivity.

The outputs of this process is currentSubmeshVertexPositions, which is a 2D array of size submeshVertexCount by 3 indicating the positions of the current frame submesh.

The following arrays are derived during the submesh positions reconstruction process:
currentSubmeshMotionVectors, which is a 2D array of size submeshVertexCount by 3 indicating for each vertex v its motion vector in current frame.
currentSubmeshPredictedMotionVectors, which is a 2D array of size submeshVertexCount by 3 indicating for each vertex v its predicted motion vector.

The k-th component of the position of the vertex with index v currentSubmeshVertexPositions[v][k] is derived as follows:

$$currentSubmeshVertexPositions [ v ] [ k ] = referenceSubmeshVertexPositions [ v ] [ k ] + c u r r e n t S u b m e s h M o tionVectors [ v ] [ k ]$$

The k-th component of the motion vector associated with the vertex with index v, currentSubmeshMotionVectors[v][k] is derived as follows:

The group index g of the vertex with index v is derived as follows:

$$g = v / motionGroupSize$$

If sismu_skip_group_flag[subMeshID][g] is equal to 1, then currentSubmeshMotionVectors[v][k]=0

The prediction mode of the vertex with index v, MvPredMode[subMeshID][v], is derived as follow:
If sismu_mv_signalled_flag[subMeshID][v] is equal to true, then MvPredMode[subMeshID][v]=MV_DERIVED

Otherwise
MvPredMode[subMeshID][v]=sismu_mv_pred_mode_group[g]

If the prediction mode, MvPredMode[subMeshID][v] is equal to MV_DERIVED, then currentSubmeshMotionVectors[v][k]=currentSubmeshMotionVectors[vRef][k]

vRef is derived as follow:
vRef=find_if(referenceSubmeshVertexPositions, v)

The function find_if(vertexPositions, v) returns an index in vertexPositions that satisfies VertexPositions[i]==v, or −1 if no such element is found.

```
vRef =firstVertexIndexDuplicated(v)
where
  firstVertexIndexDuplicated(v){
    for( i = 0; i < v; i++){
      if(referenceSubmeshVertexPositions[ i ] ==
        referenceSubmeshVertexPositions[ v ]) {
        return i
      }
    }
    return −1
  }
```

if vRef=−1, currentSubmeshMotionVectors[v][k] is set as 0.

If the prediction mode, MvPredMode[subMeshID][v] is equal to 0, then currentSubmeshMotionVectors[v][k]=VertexMotionVectorResiduals[v][k]

Otherwise, when sismu_mv_pred_mode[v] is greater than 0, then currentSubmeshMotionVectors[v][k]=VertexMotionVectorResiduals[v][k]+currentSubmeshPredictedMotionVectors[v][k]

The predicted motion vector currentSubmeshPredictedMotionVectors[v] is derived by applying the following process:

```
for( k = 0; k < 3; k++ ) {
mv[ k ] = 0
  count = 0
  for( n = 0; n < vertexNeighboursCounts[ v ]; n++ ) {
    w = vertexNeighbours[ v ][ n ]
    if ( w < v ) {
      mv[ k ] += currentSubmeshMotion \Vectors[ v ][ w]
      count += 1
    }
  }
  if ( count > 1) {
    offset = MvPredMode[subMeshID][ v ] == 2 ? count >> 1
  : 0
    if ( mv[ k ] > 0 ) {
      mv [ k ]= (mv[ k ] + offset ) / count
    } else if ( mv[ k ] < 0 ) {
      mv [ k ]= −(−mv[ k ] + offset ) / count
    }
  }
  currentSubmeshPredictedMotionVectors[ v ] = mv
}
```

### H.12.4 Vertex Neighbour Table Calculation

Inputs to this process are:
bmsps_inter_mesh_max_num_neighbours_minus1
submeshFaceCount, which is a variable indicating the number of faces in the current and in the reference submeshes.
submeshFaceIndices, which is a 2D array of size submeshFaceCount by 3 indicating the connectivity indices associated with the current and with the reference submeshes.

The outputs of this process are:
submeshVertexNeighboursCounts, which is a 1D array indicating the number of neighbours for each vertex of the submesh.
submeshVertexNeighbours, which is a 2D array of size submeshVertexCount by (bmsps_inter_mesh_max_num_neighbours_minus1+1) indicating for each vertex v the indices of its neighbours according to the mesh connectivity.

The maximum number of neighbours maxVertexNeighbourCount is set equal to bmsps_inter_mesh_max_num_neighbours_minus1+1.

```
  for( v = 0; v < submesh VertexCount; v++ ) {
    submeshVertexNeighboursCounts[ v ] = 0
  }
  for( f = 0; f < submeshFaceCount; f++ ) {
    v0 = submeshFaceIndices[ f ][ 0 ]
    v1 = submeshFaceIndices[ f ][ 1 ]
    v2 = submeshFaceIndices[ f ][ 2 ]
    AddNeighbour( v0, v1 )
    AddNeighbour( v1, v0 )
    AddNeighbour( v0, v2 )
    AddNeighbour( v2, v0 )
    AddNeighbour( v1, v2 )
    AddNeighbour( v2, v1 )
  }
  AddNeighbour( vA, vB ) {
    vertex = vA
    vertexNeighbour = vB
    availableOld = 0
    nCount = submeshVertexNeighboursCounts[vertex]
    nCount = min(nCount, maxNumNeighboursMotion)
    if (vertex > vertexNeighbour) { // Check if vertexNeighbour is available
      for (n = 0; n < nCount; ++n) {
        if (submeshVertexNeighbours[vertex][n] ==
      vertexNeighbour) {
        availableOld = 1;
        break;
        }
    }
    if (!availableOld) {
      if (nCount == maxNumNeighboursMotion) {
      submeshVertexNeighbours[vertex][maxNumNeighboursMotion −
    1] = vertexNeighbour
    } else {
      submesh VertexNeighbours[vertex][nCount] = vertexNeighbour
      submesh VertexNeighboursCounts[vertex] = nCount + 1;
      }
    }
  }
}
```

The disclosed techniques may improve the accuracy of motion estimation by computing a weighted average of multiple candidate MVs 302. These techniques may leverage a combination of multiple MVs 302, each weighted according to its relevance, and may provide a more accurate prediction than a single MV 302. By considering multiple MVs 302 and their relative importance, the weighted average may provide a more accurate prediction of the true motion. The weighted average may help to mitigate the impact of errors or outliers in the candidate MVs 302. V-DMC encoder 200 and V-DMC decoder 300 may compute a weighted average of the MVs 302 in the candidate list for current vertex v 1302 within a 3D submesh as described below.

As described above, in the current VDMC two motion vector predictors for the current motion vector (vertex index v) are computed by simple average of the MV candidates in the list for vertex v with and without rounding bias/offset as follows:

```
for( k = 0; k < 3; k++ ) { // 3 dimensions
  mv[ k ] = 0
  count = 0
  for( n = 0; n < vertexNeighboursCounts[ v ]; n++ ) {
    w = vertexNeighbours[ v ][ n ]
    if ( w < v ) {
      mv[ k ] += currentSubmeshMotionVectors[ v ][ w]
      count += 1
    }
  }
  if ( count > 1) {
    offset = MvPredMode[subMeshID][ v ] == 2 ? count >> 1
  : 0
    // rounding offset if mode == 2
    if ( mv[ k ] > 0 ) {
      mv [ k ]= (mv[ k ] + offset ) / count
    } else if ( mv[ k ] < 0 ) {
      mv [ k ]= −(−mv[ k ] + offset ) / count
    }
  }
  currentSubmeshPredictedMotionVectors[ v ] = mv
}
```

In accordance with one or more examples described in this disclosure, V-DMC encoder 200 and V-DMC decoder 300 may compute a weighted average of the MVs in the candidate list for current vertex v. The weights are determined based on a distance metric that computes a distance value between the current vertex v and the vertex position corresponding with each of the MVs in the candidate list as follows:

```
  for( k = 0; k < 3; k++ ) { // 3 dimensions
    mv[ k ] = 0
    count = 0
    distance_sum = 0
    for( n = 0; n < vertexNeighboursCounts[ v ]; n++ ) {
      w = vertexNeighbours[ v ][ n ]
      if (w < v) { // checks whether decoder will have already decoded
  vertex w
      distance_sum += distance(vertex v position, vertex w position)
      count += 1
    }
    }
    If ( count > 1) {
    // if count == 0 or count == 1 then average is not computed (omitted here
  for clarity)
      for( n = 0; n < vertexNeighboursCounts[ v ]; n++ ) {
        w = vertexNeighbours[ v ][ n ]
        distance_weight = distance_sum − distance(vertex v
  position, vertex w position)
        if ( w < v ) { // checks whether decoder will have already
  decoded vertex w
mv[ k ] += distance_weight
  currentSubmeshMotionVectors[ v ][ w ]
        }
      }
      scale = distance_sum * (count − 1) // multiplying with (count -
1) will normalize
      offset = MvPredMode[subMeshID][ v ] == 2 ? scale >> 1 : 0
      // rounding offset if mode == 2, but any mode number can be
    assigned
      if ( mv[ k ] > 0 ) {
        mv [ k ] = (mv[ k ] +offset ) / scale
      } else if ( mv[ k ] < 0 ) {
        mv [ k ] = − (−mv[ k ] + offset ) / scale
      }
    }
    currentSubmeshPredictedMotionVectors[ v ] = mv
  }
```

V-DMC encoder 200 and V-DMC decoder 300 may compute a weighted average of the MVs 302 in the candidate list for current vertex v 1302 shown in FIG. 13 within a 3D submesh as described below. For simplicity of illustration, the following techniques will be described with respect to V-DMC encoder 200 only. V-DMC encoder 200 may employ an outer loop and an inner loop. The outer loop may iterate three times, corresponding to the three dimensions (X, Y, Z). For each dimension k, V-DMC encoder 200 may initialize the array mv[k] to 0. The count and distance_sum variables may also be initialized to 0. The inner loop may iterate over the neighboring vertices (e.g., vertices 1306-1310) of the current vertex 1302. For each neighbor w: if w has already been decoded, the distance between v and w (e.g., distance between vertex 1302 and vertex 1308) may be added to the distance_sum. The count may be incremented. If count is greater than 1, the V-DMC encoder 200 may compute the weighted average as follows. For each neighbor w: the distance weight may be calculated as distance_sum−distance(v, w). V-DMC encoder 200 may add the weighted MV component for dimension k to the array mv[k]. The scale factor may be calculated to normalize the weighted sum. V-DMC encoder 200 may add an offset to the MV component based on the MvPredMode. The final MV component may be obtained by dividing the weighted sum by the scale factor, with appropriate rounding. The weight of each neighbor's MV 302 may be proportional to distance between the neighbor and the current vertex 1302. Closer neighbors may have a higher influence on the final MV 302. The process described above may be repeated for all three dimensions (X, Y, Z), ensuring accurate motion estimation in 3D space. The code may check if a neighbor has already been decoded to avoid redundant calculations. The scale factor may ensure that the weighted average is normalized, preventing excessive influence from distant neighbors.

The distance weight may be a factor that determines the influence of a particular MV 302 on the final weighted average. By making the distance weight inversely proportional to the distance between the vertices, V-DMC encoder 200 may ensure that closer vertices have a greater impact on the motion vector predictor. There are various techniques that may be used to compute the distance between two vertices. Euclidian distance is the straight-line distance between two points in Euclidean space. The Euclidian distance may be calculated as the square root of the sum of the squared differences between corresponding coordinates. The Manhattan distance may be calculated as the sum of the absolute differences of their Cartesian coordinates. The Manhattan distance is often used in scenarios where movement is restricted to grid-like patterns. The maximum difference may be calculated as the largest absolute difference between corresponding coordinates. This metric may be useful when the focus is on the largest discrepancy between dimensions. In a 3D space, Euclidean distance may be preferred to calculate the direct distance between two points.

In an aspect, multiple predictors may be used by V-DMC encoder 200 to estimate the MV 302 (e.g., to determine a motion vector predictor for MV 302) of the current vertex 1302. The distance-weighted average predictor may assign weights to neighboring vertices (e.g., vertices 1306-1310) based on their distance from the current vertex 1302. Closer vertices may have higher weights, and their MVs 1302 may contribute more to the final prediction. Simple average predictor may calculate the average MV 302 of neighboring vertices without considering their distances. By using multiple predictors, V-DMC encoder 200 may select the best predictor for each vertex, potentially improving coding efficiency. In an example, the best predictor may be selected based on a cost function. The cost function may be used to evaluate the quality of each predictor. This cost function may consider factors such as, but not limited to: bits required to encode the predictor mode (i.e., which predictor is used), bits required to encode the residual error between the predicted MV and the actual MV, distortion metric (e.g., rate-distortion optimization). The skip mode may be used by V-DMC encoder 200 to skip motion compensation for certain vertices, further reducing the bitrate. V-DMC encoder 200 may group vertices together to share the same motion vector, reducing the number of MVs 302 that need to be encoded.

In an aspect, V-DMC encoder 200 may calculate the residual after the best predictor has been selected. The residual may be the difference between the actual motion vector (MV) 302 of the current vertex (v) 1302 and the predicted motion vector obtained from the best predictor. V-DMC encoder 200 may encode the calculated residual into the bitstream 930 for transmission or storage.

In some examples, MV predictors may rely on the MVs 302 of other vertices (e.g., vertices 1304-1310) in the current frame. To better ensure that these MVs 302 are available for prediction, the vertices should be decoded in a specific order.

In accordance with one or more examples described in this disclosure, V-DMC encoder 200 may employ inter-frame prediction. The inter-frame prediction techniques may leverage the temporal redundancy between consecutive frames to improve coding efficiency. By utilizing motion vectors from previously decoded frames (reference frames or meshes), V-DMC encoder 200 may predict the motion vector of a current vertex of the current frame more accurately.

A variety of predictors may be employed by V-DMC encoder 200 to estimate the motion vector 302 of the current vertex 1302. The list of potential predictors may include, but is not limited to: zero MV, simple average, distance-weighted average, and reference frame MV 302. The zero MV may be a simple predictor that assumes no motion. The simple average predictor may determine the average of the motion vectors 302 of neighboring vertices (e.g., vertices 1306-1310). The distance-weighted average predictor may be a weighted average of the motion vectors of neighboring vertices, where the weights may be inversely proportional to the distance from the current vertex 1302. The reference frame MV predictor may comprise the motion vector 302 of the corresponding vertex in a previously decoded reference frame. If the topology of the current and reference meshes is the same, the motion vector 302 of the corresponding vertex in the reference frame may be directly used as a predictor. In cases where the topologies differ, index remapping or nearest-neighbor techniques may be employed to find the suitable corresponding vertex in the reference frame.

In the conventional V-DMC, when the candidate list for motion vector predictors reaches its maximum capacity, a simple strategy may be employed: the last element in the list is replaced with the next candidate MV. This technique, while straightforward, may not always yield the accurate set of predictors. To enhance the quality of MV prediction, V-DMC encoder 200 may implement the disclosed techniques to calculate the distance between the current vertex (v) 302 and the vertex (w) corresponding to the next candidate MV 302. V-DMC encoder 200 may employ the distance metrics described above, such as but not limited to, Euclidean distance, Manhattan distance, or maximum difference for this calculation. If the list is not full, the new candidate MV 302 may be directly added to the list. If the list is full, the candidate MV 302 with the largest distance to the current vertex may be replaced with the new candidate MV. By prioritizing candidates that are closer to the current vertex 1302, the V-DMC encoder 200 may improve the accuracy of the average-based predictors because nearby vertices may be more likely to have similar motion characteristics. By selecting more relevant candidates, the average-based predictors may produce more accurate MV estimates. More accurate MV predictions may lead to smaller residual errors, resulting in lower bitrates.

In one example, when the candidate list is full, the distance value of the next candidate MV 302 may be compared to the distance values of the existing candidates in the list, one by one. The first candidate in the candidate list with a larger distance value may be replaced with the new candidate. This technique may better ensure that the candidate list always contains the closest vertices to the current vertex 1302, potentially leading to more accurate motion vector prediction.

In an example, when the candidate list is full, similar to the previous technique, the V-DMC encoder 200 may compare the distance value of the next candidate MV to the distance values of the existing candidates. The first candidate with a larger distance value may be removed from the list, and the new candidate may be added to the end or a specific position in the list. This technique allows for a more dynamic update of the candidate list, potentially incorporating more diverse information from neighboring vertices. The choice of distance metric (e.g., Euclidean, Manhattan, Chebyshev) may significantly impact the performance of these techniques. The size of the candidate list may influence the trade-off between computational complexity and prediction accuracy.

In one example, when the list is full, the V-DMC encoder 200 may determine the maximum distance value among the current candidates in the list. V-DMC encoder 200 may compare the distance of the next candidate MV 302 to this maximum distance. If the distance of the next candidate is smaller than the maximum distance, V-DMC encoder 200 may replace the candidate with the largest distance with the new candidate. By replacing the candidate with the largest distance, this technique may better ensure that the candidate list always contains the closest vertices to the current vertex 1302. This may lead to more accurate motion vector prediction. This technique may be more efficient than comparing the next candidate to each existing candidate individually. By prioritizing closer vertices, the predictor may better capture local motion patterns.

Many alternative substitutions may be employed to construct the candidate list.

In VDMC and in examples described above, it is assumed that the motion vector candidates originate from neighboring vertices (e.g., vertices 1306-1310) that are in the same plane as the current vertex 1302, because the 3D positions of the vertices corresponding with candidate MVs relative to the 3D position of the current are not considered.

In accordance with one or more examples described in this disclosure, it is proposed to take the relative 3D positions into consideration to correct or weight the candidate MVs in the list.

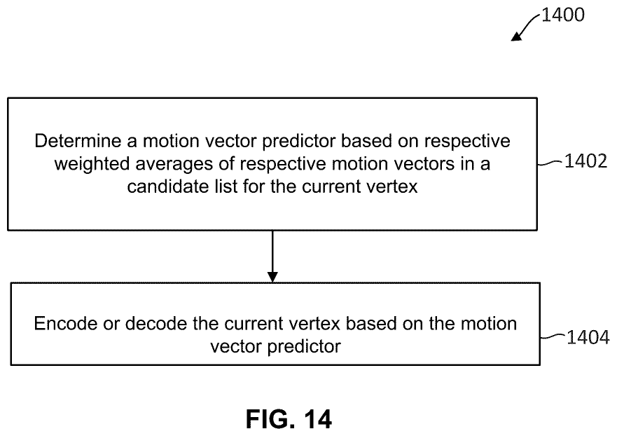

FIG. 14 is a flowchart illustrating an example method for encoding and decoding meshes, in accordance with the techniques of this disclosure. Although described with respect to V-DMC encoder 200 and V-DMC decoder 300 (FIG. 1), it should be understood that other devices may be configured to perform a method similar to that of FIG. 14.

In this example, for a current vertex of mesh vertices of the mesh data, V-DMC encoder 200 or V-DMC decoder 300 may determine a motion vector predictor based on respective weighted averages of respective motion vectors in a candidate list for the current vertex (1402). Motion vector predictors may be used to predict the motion of a particular mesh vertex based on the motion of its neighboring vertices. By accurately predicting the motion, V-DMC encoder 200 and/or V-DMC decoder 300 may reduce the amount of information needed to represent the actual motion. V-DMC encoder 200 may encode and/or V-DMC decoder 300 may decode the current vertex based on the motion vector predictor (1404). By using multiple predictors, V-DMC encoder 200 may select the best predictor for each vertex, potentially improving coding efficiency.

In one example, the current vertex may be in a current mesh, and at least one of the motion vectors in the candidate list for the current vertex may be based on a motion vector of a reference vertex in a reference mesh.

In one example, an index identifying the reference vertex may be same as an index identifying the current vertex in a condition where a topology of the current mesh and the reference mesh being the same.

In one example, the reference vertex may be identified based on index remapping or based on nearest vertex position in reference mesh to position of current vertex in current mesh in a condition where a topology of the current mesh and the reference mesh is different.

In one example, V-DMC encoder 200 or V-DMC decoder 300 may determine the respective weighted averages based on a respective distance between the current vertex and respective vertex position corresponding to each of the motion vectors.

In one example, the respective distance may be determined based on at least one of a Euclidean distance, Manhattan distance, maximum difference between position components, or a combination thereof.

In one example, the motion vector predictor may be a first motion vector predictor. The respective weighted averages may include first respective weighted averages. V-DMC encoder 200 or V-DMC decoder 300 may, for the current vertex of the mesh vertices of the mesh data, determine a second motion vector predictor based on second respective weighted averages of respective motion vectors in the candidate list for the current vertex. Encoding or decoding the current vertex may include encoding or decoding the current vertex based on the first motion vector predictor and the second motion vector predictor.

In one example, V-DMC encoder 200 or V-DMC decoder 300 may determine an additional motion vector predictor based on at least one of: zero motion vector, simple average without rounding, simple average with rounding, distance-weighted average without rounding, or distance-weighted average with rounding. Encoding or decoding the current vertex may include encoding or decoding the current vertex based additionally on the additional motion vector predictor.

In one example, V-DMC encoder 200 or V-DMC decoder 300 may construct the candidate list for the current vertex. Constructing the candidate list may include at least one of: adding motion vectors of vertices in a current mesh that includes the current vertex, adding motion vectors of vertices in a reference mesh that was previously encoded or decoded, or addition motion vectors of vertices in the current mesh and motion vectors of vertices in the reference mesh.

In one example, constructing the candidate list may include, in a condition where the candidate list is full: determining a distance value between a first position corresponding to a candidate motion vector; comparing the distance value to respective distance values of motion vectors in the candidate list; and based on the comparison, removing a motion vector from the candidate list, and adding the candidate motion vector.

In one example, the removed motion vector has the largest distance in the candidate list.

In one example, V-DMC encoder 200 or V-DMC decoder 300 may generate the mesh data.

The following describes example techniques that may be performed together or separately.

Clause 1. A method of encoding or decoding mesh data, the method comprising: for a current vertex of mesh vertices of the mesh data, determining a motion vector predictor based on respective weighted averages of respective motion vectors in a candidate list for the current vertex; and encoding or decoding the current vertex based on the motion vector predictor.

Clause 2. The method of clause 1, wherein the current vertex is in a current mesh, and wherein at least one of the motion vectors in the candidate list for the current vertex is based on a motion vector of a reference vertex in the current mesh.

Clause 3. The method of clause 2, wherein an index identifying the reference vertex is same as an index identifying the current vertex in a condition where a topology of the current mesh and the reference mesh being the same.

Clause 4. The method of clause 2, wherein the reference vertex is identified based on index remapping or based on nearest vertex position in reference mesh to position of current vertex in current mesh in a condition where a topology of the current mesh and the reference mesh is different.

Clause 5. The method of clause 1, further comprising: determining the respective weighted averages based on a respective distance between the current vertex and respective vertex position corresponding to each of the motion vectors.

Clause 6. The method of clause 5, wherein the respective distance is determined based on at least one of a Euclidean distance, Manhattan distance, maximum difference between position components, or a combination thereof.

Clause 7. The method of any of clauses 1-6, wherein the motion vector predictor is a first motion vector predictor, wherein the respective weighted averages comprise first respective weighted averages, the method further comprising: for the current vertex of the mesh vertices of the mesh data, determining a second motion vector predictor based on second respective weighted averages of respective motion vectors in the candidate list for the current vertex, wherein encoding or decoding the current vertex comprises encoding or decoding the current vertex based on the first motion vector predictor and the second motion vector predictor.

Clause 8. The method of any of clauses 1-7, further comprising:
determining an additional motion vector predictor based on at least one of: zero motion vector, simple average without rounding, simple average with rounding, distance-weighted average without rounding, or distance-weighted average with rounding, wherein encoding or decoding the current vertex comprises encoding or decoding the current vertex based additionally on the additional motion vector predictor.

Clause 9. The method of any of clauses 1-8, further comprising:
constructing the candidate list for the current vertex, wherein constructing the candidate list comprises at least one of: adding motion vectors of vertices in a current mesh that includes the current vertex, adding motion vectors of vertices in a reference mesh that was previously encoded or decoded, or addition motion vectors of vertices in the current mesh and motion vectors of vertices in the reference mesh.

Clause 10. The method of clause 9, wherein constructing the candidate list comprises, in a condition where the candidate list is full: determining a distance value between a first position corresponding to a candidate motion vector; comparing the distance value to respective distance values of motion vectors in the candidate list; and based on the comparison, removing a motion vector from the candidate list, and adding the candidate motion vector.

Clause 11. The method of clause 10, wherein the removed motion vector has the largest distance in the candidate list.

Clause 12. The method of any of clauses 1-11, further comprising generating the mesh data.

Clause 13. A device for generating mesh data, the device comprising: a memory configured to store the mesh data; and one or more processors coupled to the memory, implemented in circuitry, and configured to: for a current vertex of mesh vertices of the mesh data, determine a motion vector predictor based on respective weighted averages of respective motion vectors in a candidate list for the current vertex; and encode or decode the current vertex based on the motion vector predictor.

Clause 14. The device of clause 13, wherein the current vertex is in a current mesh, and wherein at least one of the motion vectors in the candidate list for the current vertex is based on a motion vector of a reference vertex in the current mesh.

Clause 15. The device of clause 14, wherein an index identifying the reference vertex is same as an index identifying the current vertex in a condition where a topology of the current mesh and the reference mesh being the same.

Clause 16. The device of clause 14, wherein the reference vertex is identified based on index remapping or based on nearest vertex position in reference mesh to position of current vertex in current mesh in a condition where a topology of the current mesh and the reference mesh is different.

Clause 17. The device of clause 13, wherein the one or more processors are further configured to: determine the respective weighted averages based on a respective distance between the current vertex and respective vertex position corresponding to each of the motion vectors.

Clause 18. The device of clause 17, wherein the respective distance is determined based on at least one of a Euclidean distance, Manhattan distance, maximum difference between position components, or a combination thereof.

Clause 19. The device of any of clauses 13-18, wherein the motion vector predictor is a first motion vector predictor, wherein the respective weighted averages comprise first respective weighted averages, and wherein the one or more processors are further configured to: for the current vertex of the mesh vertices of the mesh data, determine a second motion vector predictor based on second respective weighted averages of respective motion vectors in the candidate list for the current vertex, wherein the one or more processors configured to encode or decode the current vertex are further configured to decode the current vertex based on the first motion vector predictor and the second motion vector predictor.

Clause 20. The device of any of clauses 13-19, wherein the one or more processors are further configured to: determine an additional motion vector predictor based on at least one of: zero motion vector, simple average without rounding, simple average with rounding, distance-weighted average without rounding, or distance-weighted average with rounding, wherein the one or more processors configured to encode or decode the current vertex are further configured to encode or decode the current vertex based on the first motion vector predictor and the second motion vector predictor.

Clause 21. The device of any of clauses 13-20, wherein the one or more processors are further configured to: construct the candidate list for the current vertex, and wherein the one or more processors configured to construct the candidate list are configured to at least one of: add motion vectors of vertices in a current mesh that includes the current vertex, add motion vectors of vertices in a reference mesh that was previously encoded or decoded, or add motion vectors of vertices in the current mesh and motion vectors of vertices in the reference mesh.

Clause 22. The device of clause 20, wherein the one or more processors configured to construct the candidate list is configured to, in a condition where the candidate list is full: determine a distance value between a first position corresponding to a candidate motion vector; compare the distance value to respective distance values of motion vectors in the candidate list; and based on the comparison, remove a motion vector from the candidate list, and add the candidate motion vector.

Clause 23. The device of clause 22, wherein the removed motion vector has the largest distance in the candidate list.

Clause 24. The device of any of clauses 13-23, wherein the one or more processors are further configured to generate the mesh data.

Clause 25. Non-transitory computer-readable storage media having instructions encoded thereon, the instructions configured to cause processing circuitry to: for a current vertex of mesh vertices of the mesh data, determine a motion vector predictor based on respective weighted averages of respective motion vectors in a candidate list for the current vertex; and encode or decode the current vertex based on the motion vector predictor.

Clause 26. The storage media of clause 25, wherein the current vertex is in a current mesh, and wherein at least one of the motion vectors in the candidate list for the current vertex is based on a motion vector of a reference vertex in the current mesh.

Clause 27. The storage media of clause 26, wherein an index identifying the reference vertex is same as an index identifying the current vertex in a condition where a topology of the current mesh and the reference mesh being the same.

Clause 28. The storage media of clause 26, wherein the reference vertex is identified based on index remapping or based on nearest vertex position in reference mesh to position of current vertex in current mesh in a condition where a topology of the current mesh and the reference mesh is different.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of encoding or decoding mesh data, the method comprising:
for a current vertex of mesh vertices of the mesh data, determining a motion vector predictor based on respective weighted averages of respective motion vectors in a candidate list for the current vertex; and
encoding or decoding the current vertex based on the motion vector predictor.

2. The method of claim 1, wherein the current vertex is in a current mesh, and wherein at least one of the motion vectors in the candidate list for the current vertex is based on a motion vector of a reference vertex in the current mesh.

3. The method of claim 2, wherein an index identifying the reference vertex is same as an index identifying the current vertex in a condition where a topology of the current mesh and the reference mesh being the same.

4. The method of claim 2, wherein the reference vertex is identified based on index remapping or based on nearest vertex position in reference mesh to position of current vertex in current mesh in a condition where a topology of the current mesh and the reference mesh is different.

5. The method of claim 1, further comprising:
determining the respective weighted averages based on a respective distance between the current vertex and respective vertex position corresponding to each of the motion vectors.

6. The method of claim 5, wherein the respective distance is determined based on at least one of a Euclidean distance, Manhattan distance, maximum difference between position components, or a combination thereof.

7. The method of claim 1, wherein the motion vector predictor is a first motion vector predictor, wherein the respective weighted averages comprise first respective weighted averages, the method further comprising:
for the current vertex of the mesh vertices of the mesh data, determining a second motion vector predictor based on second respective weighted averages of respective motion vectors in the candidate list for the current vertex,
wherein encoding or decoding the current vertex comprises encoding or decoding the current vertex based on the first motion vector predictor and the second motion vector predictor.

8. The method of claim 1, further comprising:
determining an additional motion vector predictor based on at least one of: zero motion vector, simple average without rounding, simple average with rounding, distance-weighted average without rounding, or distance-weighted average with rounding,
wherein encoding or decoding the current vertex comprises encoding or decoding the current vertex based additionally on the additional motion vector predictor.

9. The method of claim 1, further comprising:
constructing the candidate list for the current vertex, wherein constructing the candidate list comprises at least one of: adding motion vectors of vertices in a current mesh that includes the current vertex, adding motion vectors of vertices in a reference mesh that was previously encoded or decoded, or addition motion vectors of vertices in the current mesh and motion vectors of vertices in the reference mesh.

10. The method of claim 9, wherein constructing the candidate list comprises, in a condition where the candidate list is full:
determining a distance value between a first position corresponding to a candidate motion vector;
comparing the distance value to respective distance values of motion vectors in the candidate list; and
based on the comparison, removing a motion vector from the candidate list, and adding the candidate motion vector.

11. The method of claim 10, wherein the removed motion vector has the largest distance in the candidate list.

12. The method of claim 1, further comprising generating the mesh data.

13. A device for generating mesh data, the device comprising:
a memory configured to store the mesh data; and
one or more processors coupled to the memory, implemented in circuitry, and configured to:
for a current vertex of mesh vertices of the mesh data, determine a motion vector predictor based on respective weighted averages of respective motion vectors in a candidate list for the current vertex; and
encode or decode the current vertex based on the motion vector predictor.

14. The device of claim 13, wherein the current vertex is in a current mesh, and wherein at least one of the motion vectors in the candidate list for the current vertex is based on a motion vector of a reference vertex in the current mesh.

15. The device of claim 14, wherein an index identifying the reference vertex is same as an index identifying the current vertex in a condition where a topology of the current mesh and the reference mesh being the same.

16. The device of claim 14, wherein the reference vertex is identified based on index remapping or based on nearest vertex position in reference mesh to position of current vertex in current mesh in a condition where a topology of the current mesh and the reference mesh is different.

17. The device of claim 13, wherein the one or more processors are further configured to:
determine the respective weighted averages based on a respective distance between the current vertex and respective vertex position corresponding to each of the motion vectors.

18. The device of claim 17, wherein the respective distance is determined based on at least one of a Euclidean distance, Manhattan distance, maximum difference between position components, or a combination thereof.

19. The device of claim 13, wherein the motion vector predictor is a first motion vector predictor, wherein the respective weighted averages comprise first respective weighted averages, and wherein the one or more processors are further configured to:
for the current vertex of the mesh vertices of the mesh data, determine a second motion vector predictor based on second respective weighted averages of respective motion vectors in the candidate list for the current vertex,
wherein the one or more processors configured to encode or decode the current vertex are further configured to decode the current vertex based on the first motion vector predictor and the second motion vector predictor.

20. The device of claim 13, wherein the one or more processors are further configured to:
determine an additional motion vector predictor based on at least one of: zero motion vector, simple average without rounding, simple average with rounding, distance-weighted average without rounding, or distance-weighted average with rounding,
wherein the one or more processors configured to encode or decode the current vertex are further configured to encode or decode the current vertex based on the first motion vector predictor and the second motion vector predictor.

21. The device of claim 13, wherein the one or more processors are further configured to:
construct the candidate list for the current vertex, and wherein the one or more processors configured to construct the candidate list are configured to at least one of: add motion vectors of vertices in a current mesh that includes the current vertex, add motion vectors of vertices in a reference mesh that was previously encoded or decoded, or add motion vectors of vertices in the current mesh and motion vectors of vertices in the reference mesh.

22. The device of claim 20, wherein the one or more processors configured to construct the candidate list is configured to, in a condition where the candidate list is full:
determine a distance value between a first position corresponding to a candidate motion vector;
compare the distance value to respective distance values of motion vectors in the candidate list; and
based on the comparison, remove a motion vector from the candidate list, and add the candidate motion vector.

23. The device of claim 22, wherein the removed motion vector has the largest distance in the candidate list.

24. The device of claim 13, wherein the one or more processors are further configured to generate the mesh data.

25. Non-transitory computer-readable storage media having instructions encoded thereon, the instructions configured to cause processing circuitry to:
for a current vertex of mesh vertices of the mesh data, determine a motion vector predictor based on respective weighted averages of respective motion vectors in a candidate list for the current vertex; and
encode or decode the current vertex based on the motion vector predictor.

26. The storage media of claim 25, wherein the current vertex is in a current mesh, and wherein at least one of the motion vectors in the candidate list for the current vertex is based on a motion vector of a reference vertex in the current mesh.

27. The storage media of claim 26, wherein an index identifying the reference vertex is same as an index identifying the current vertex in a condition where a topology of the current mesh and the reference mesh being the same.

28. The storage media of claim 26, wherein the reference vertex is identified based on index remapping or based on nearest vertex position in reference mesh to position of current vertex in current mesh in a condition where a topology of the current mesh and the reference mesh is different.
